(19) United States
(12) Patent Application Publication
(10) Pub. No.: US 2021/0120735 A1
(43) Pub. Date: Apr. 29, 2021

(54) GRASS CUTTER BLADES FOR PREVENTING GRASS FROM WINDING

(71) Applicant: Jae Hee KIM, Gyeongsangnam-do (KR)

(72) Inventor: Jae Hee KIM, Gyeongsangnam-do (KR)

(21) Appl. No.: 16/326,010

(22) PCT Filed: Aug. 10, 2017
(86) PCT No.: PCT/KR2017/008670

§ 371 Date: Feb. 15, 2019

(30) Foreign Application Priority Data
Nov. 15, 2016 (KR) 10-2016-0152176

(51) Int. Cl. A01D 34/73; A01D 34/82

(52) U.S. Cl. CPC A01D 34/73; A01D 34/67; A01D 34/828

(57) ABSTRACT

Grass cutter blades for preventing grass from winding meet safety standards for industrial products subject to safety self-assurance. To this end, the grass cutter blades are installed on a rotating shaft applying a rotational force of a grass cutter. The grass cutter blades form a hexagonal shape as a whole, comprise a front side having a first blade portion and a rear side having a second blade portion, have a first fixing hole fitted to the rotating shaft, comprises a horizontal blade having through holes, which face each other with the first fixing hole therebetween, and have a vertical blade inserted into the through holes.

### BACKGROUND

The present invention relates to grass cutter blades for preventing grass from winding and, more particularly, to grass cutter blades, for preventing grass from winding, which meet safety standards for industrial products subject to safety self-assurance under Article 19(2) of the Act on the Quality Management and Safety Control of Industrial Products.

### BACKGROUND ART

A portable power grass cutter is widely available in farm households as well as general households so as to conveniently cut grass on the ridge between rice paddies, gardens, orchards, graves, and the like.

In a state where such portable power grass cutter is worn on a user's back or shoulder, blades of the grass cutter rotate at a high speed to cut grass, and accordingly, the grass cutter has structural dangers.

Due to the structural dangers of the grass cutter, especially, the user may be torn or pierced, and accordingly, there is a need to safely use the grass cutter.

On the other hand, the grass cutter with two blades has been generally used in view of workability and prices thereof, and particularly, since the grass cutter with integral type two blades has excellent workability, it is preferred by many users.

The reason why the grass cutter with two blades is preferred is that since the two blades are proposed from the time when the grass cutter is initially introduced and prevailed, most of users are accustomed to the two blades. The grass cutter with two blades has excellent workability, and through the grass cutter with two blades, therefore, it is convenient to cut trees as well as grass. Accordingly, the users who use the grass cutter with two blades rarely want to use the grass cutter with three or four blades.

One example of conventional grass cutter blades is disclosed in Korean Patent Registration No. 10-1531663 “Grass cutter blade”, wherein various use states of the grass cutter with two blades are suggested.

According to the above-mentioned prior art, the grass cutter blades are configured to have auxiliary blade portions formed thereon to in advance cut grass wound on a space between a gear case and the blades or grass wound on the gear case, thereby increasing working efficiencies, decreasing working time, and improving the user's safety and conveniences.

The grass cutter blades have to be machined and used to meet safety standards for industrial products subject to safety self-assurance under Article 19(2) of the Act on the Quality Management and Safety Control of Industrial Products.

According to the above-mentioned prior art, however, edges of a first machined portion 111 and a second machined portion 121 have an angle of 90°, as shown in FIG. 1.

The edges of the first machined portion 111 and the second machined portion 121 have to have an obtuse angle, desirably, an angle of 98°, which undesirably fails to meet the Act on the Quality Management and Safety Control of Industrial Products, so that the conventional grass cutter blades are not commercially available.

Prior Art Document: (Patent Document 0001) Korean Patent Registration No. 10-1531663 “Grass cutter blade”

### SUMMARY OF THE INVENTION

Accordingly, the present invention has been made in view of the above-mentioned problems occurring in the prior art, and it is an object of the present invention to provide grass cutter blades for preventing grass from winding that meet the Act on the Quality Management and Safety Control of Industrial Products, prevent grass fitting during grass cuts, and even if a given blade portion is damaged, make use of the other side blade portion.

To accomplish the above object, according to the present invention, there are provided grass cutter blades, for preventing grass from winding, which are fitted to a rotating shaft applying a rotational force thereto, including: a horizontal blade taking a general hexagonal shape and having a first blade portion formed on a front side thereof, a second blade portion formed on a rear side thereof, a first fixing hole fitted to the rotating shaft, a side wall formed unitarily with the first fixing hole by means of bulging or drawing in such a manner as to surround the outer peripheral surface of an upper holder to basically prevent the grass from winding, and through holes formed to face each other in placing the first fixing hole therebetween; and a vertical blade adapted to be inserted into the through holes of the horizontal blade.

According to the present invention, further, the vertical blade includes a base plate disposed on the underside of the horizontal blade, a second fixing hole formed on the same axial line as the first fixing hole of the horizontal blade, and side blades facingly extended protrudingly from both sides of the base plate in placing the second fixing hole therebetween.

According to the present invention, desirably, the horizontal blade has four through holes and the vertical blade has four side blades.

Other objects and effects of the present invention as will be discussed later will be in detail described, and therefore, the detailed explanation and embodiment of the present invention do not limit the idea and technical scope of the invention.

### Advantageous Effects

According to the present invention, the grass cutter blades for preventing grass from winding are configured to have the first blade portion and the second blade portion formed on the front and rear sides of the horizontal blade, so that even if the first blade portion is damaged, the horizontal blade is turned over to use the second blade portion, thereby giving economical advantages, and further configured to couple the vertical blade to the horizontal blade to prevent grass from winding fittedly to the space between the upper holder and the horizontal blade, thereby increasing working efficiencies.

In addition, the grass cutter blades for preventing grass from winding according to the present invention have two blades meeting the Act on the Quality Management and Safety Control of Industrial Products, thereby causing no problem in the industrial use thereof.

### BRIEF DESCRIPTION OF DRAWINGS

FIG. 1 is a top view showing conventional grass cutter blades.

FIG. 2 is an exploded sectional view showing grass cutter blades for preventing grass from winding according to the present invention.

FIG. 3 is a sectional view of showing an assembled state of the grass cutter blades of FIG. 2.

FIGS. 4a to 4c are plan views showing examples of a horizontal blade according to the present invention.

FIGS. 5a and 5b are plan views showing examples of a vertical blade according to the present invention.

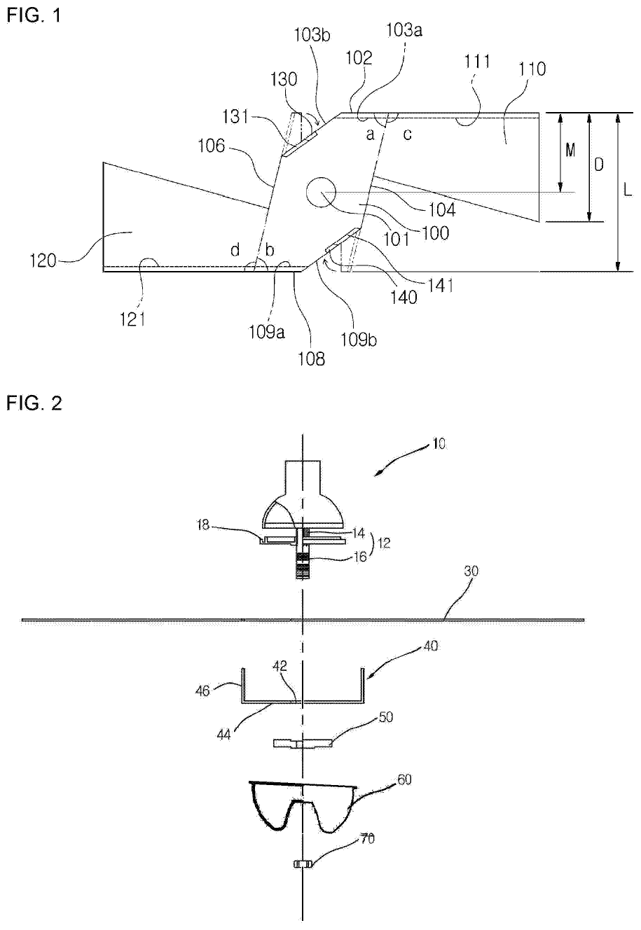

Explanations on Main Reference Numerals in the Drawings

| | |
|---|---|
| 10: gear box | 20: upper holder |
| 30: horizontal blade | 40: vertical blade |
| 50: lower holder | 60: safety plate |
| 70: fixing member | |

### DETAILED DESCRIPTION OF THE INVENTION

The present invention relates to grass cutter blades for preventing grass from winding which are fitted to a rotating shaft applying a rotational force thereto, the grass cutter blades including: a horizontal blade taking a general hexagonal shape and having a first blade portion formed on a front side thereof, a second blade portion formed on a rear side thereof, a first fixing hole fitted to the rotating shaft, a side wall formed unitarily with the first fixing hole by means of bulging or drawing in such a manner as to surround the outer peripheral surface of an upper holder to basically prevent the grass from winding, and through holes formed to face each other in placing the first fixing hole therebetween; and a vertical blade adapted to be inserted into the through holes of the horizontal blade.

### MODE FOR INVENTION

Hereinafter, an explanation on one preferred embodiment of the present invention will be in detail given with reference to the attached drawing. Through the accompanying drawings, the same reference numerals will be used to describe the same components and an overlapped description of the same components will be omitted.

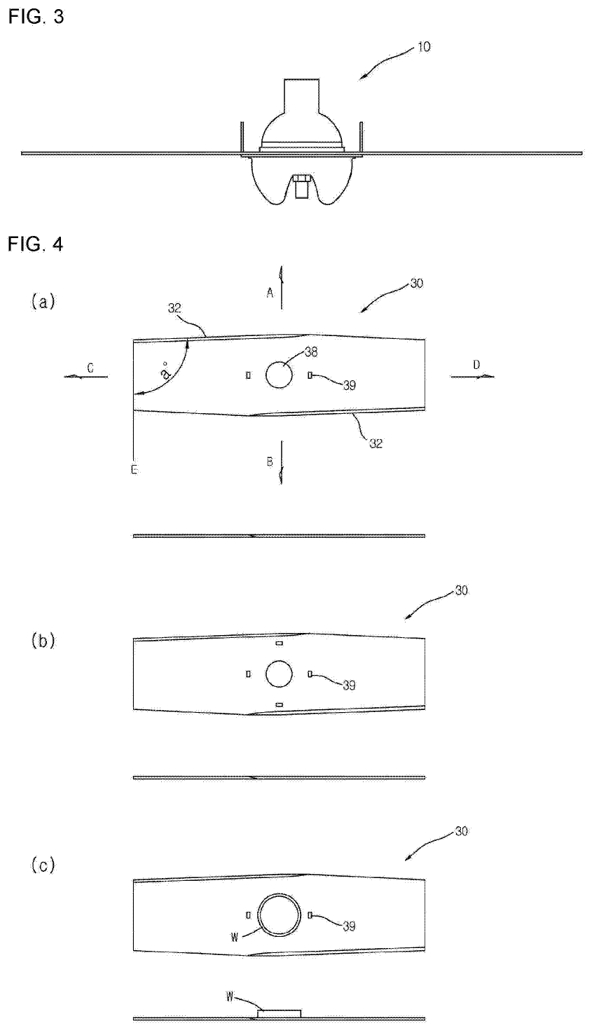

FIG. 2 is an exploded sectional view showing grass cutter blades for preventing grass from winding according to the present invention, and FIG. 3 is a sectional view of showing an assembled state of the grass cutter blades according to the present invention.

As shown in FIGS. 2 and 3, a gear box 10 adopted in the present invention transfers a rotational force generated from an engine to a rotating shaft 12 through bevel gears disposed therein.

The rotating shaft 12 to which a spline 14 is fitted is formed unitarily with a screw portion 16 on the lower periphery thereof.

An upper holder 20 is inserted into the spline 14, and a horizontal blade 30 is insertedly fitted to underside of the upper holder 20.

As shown in FIG. 4a, the horizontal blade 30 has a general hexagonal shape.

The term ‘front side’, as used herein, indicates a direction of A, the term ‘rear side’ a direction of B, the term ‘left side’ a direction of C, and the term ‘right side’ a direction of D.

The horizontal blade 30 has a first blade portion 32 formed on the front side thereof and a second blade portion 34 formed on the rear side thereof.

The first blade portion 32 and the second blade portion 34 are formed in a direction crossing each other. For example, the first blade portion 32 formed on the left side and the second blade portion 34 formed on the right side rotate in a clockwise direction, so that they cut grass or the like.

The left and right sides of the horizontal blade 30 are symmetrically formed, and even if the horizontal blade 30 is used in a state of being turned over, accordingly, the first blade portion 32 and the second blade portion 34 are located on the same positions.

The horizontal blade 30 has a first fixing hole 38 formed on the center of weight thereof to insert the rotating shaft 12 thereinto, and top of the horizontal blade 30 comes into close contact with the upper holder 20.

The first blade portion 32 and the second blade portion 34 have an angle greater than 98° with respect to the lateral side E as shown in FIG. 4a, thereby meeting the Act on the Quality Management and Safety Control of Industrial Products.

Further, the horizontal blade 30 has through holes 39 formed in a state of placing the first fixing hole 38 therebetween, and as shown in FIG. 4b, of course, the horizontal blade 30 may have four through holes 39.

Desirably, each through hole 39 has a shape of a square or rectangle.

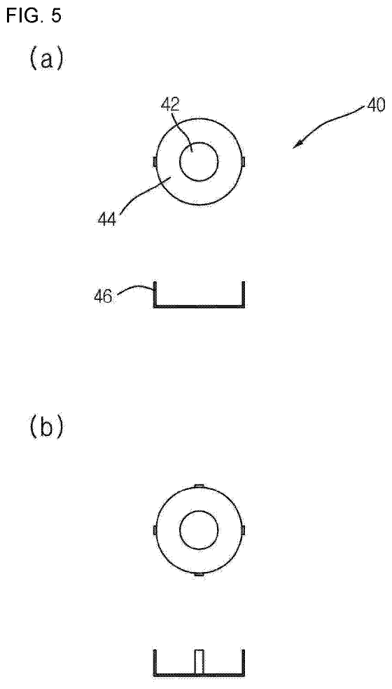

As shown in FIG. 5a, a vertical blade 40 has a second fixing hole 42 formed on the same axial line as the first fixing hole 38 of the horizontal blade 30, and the center of the second fixing hole 42 is the center of weight of the vertical blade 40 when viewed on the plane.

The second fixing hole 42 is formed on a base plate 44, and side blades 46 are symmetrically extended protrudingly from both sides of the base plate 44.

The side blades 46 are inserted into the through holes 39 of the horizontal blade 30, and at this time, the inserted side blades 46 are locked onto the through holes 39 to prevent their escape during rotation.

Further, if the four through holes 39 are formed as shown in FIG. 4b, the four side blades 46 are provided as shown in FIG. 5b.

The vertical blade 40 is located on the underside of the horizontal blade 30, and the rotating shaft 12 is inserted into the second fixing hole 42.

A lower holder 50 is brought into close contact with the underside of the vertical blade 40 fitted to the rotating shaft 12 and is then fitted to the rotating shaft 12. So as to allow the lower holder 50 to fixedly come into the contact with the vertical blade 40, a safety plate 60 is fitted sequentially to the rotating shaft 12.

The respective components sequentially fitted to the rotating shaft 12 are fastened to the screw portion 16 of the rotating shaft 12 by means of a fixing member 70 like a nut, and further, the safety plate 60 is pushed upward to permit the respectively components to be rigidly coupled to each other.

The vertical blade 40 protrudes from top of the horizontal blade 30, and if the horizontal blade 30 rotates, the vertical blade 40 also rotates, thereby preventing grass from winding on a space between the horizontal blade 30 and the upper holder 20 like the conventional practice.

In detail, the side blades 46 of the vertical blade 40 serve to cut the wound grass or the grass to be wound, thereby basically preventing the grass from winding. Accordingly, there is no need to perform inconvenient work such as engine stop and wound grass removal, thereby increasing working efficiencies and avoiding the danger of removing the wound grass by means of a user's hand.

On the other hand, if the first fixing hole 38 is formed on the horizontal blade 30 to prevent grass from winding on the space between the horizontal blade 30 and the upper holder 20, the first fixing hole 38 is formed unitarily with a side wall W through bulging or drawing, as shown in FIG. 4c, and the side wall W serves to surround the outer peripheral surface of the upper holder 20 to completely prevent the grass from winding.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

### INDUSTRIAL APPLICABILITY

The grass cutter blades for preventing grass from winding according to the present invention are configured to have the first blade portion and the second blade portion formed on the front and rear sides of the horizontal blade, so that even if the first blade portion is damaged, the horizontal blade is turned over to use the second blade portion, thereby giving economical advantages, and further configured to couple the vertical blade to the horizontal blade to prevent grass from winding fittedly to the space between the upper holder and the horizontal blade, thereby increasing working efficiencies. Therefore, the present invention has high industrial applicability.

1. Grass cutter blades for preventing grass from winding, which are fitted to a rotating shaft applying a rotational force thereto, comprising:
a horizontal blade taking a general hexagonal shape and having a first blade portion formed on a front side thereof, a second blade portion formed on a rear side thereof, a first fixing hole fitted to the rotating shaft, a side wall formed unitarily with the first fixing hole by means of bulging or drawing in such a manner as to surround the outer peripheral surface of an upper holder to basically prevent the grass from winding, and through holes formed to face each other in placing the first fixing hole therebetween; and
a vertical blade adapted to be inserted into the through holes of the horizontal blade.

2. The grass cutter blades according to claim 1, wherein the vertical blade comprises a base plate disposed on the underside of the horizontal blade, a second fixing hole formed on the same axial line as the first fixing hole of the horizontal blade, and side blades facingly extended protrudingly from both sides of the base plate in placing the second fixing hole therebetween.

3. The grass cutter blades according to claim 2, wherein the horizontal blade has four through holes and the vertical blade has four side blades.
